(19) United States
(12) Patent Application Publication
(10) Pub. No.: US 2025/0360510 A1
(43) Pub. Date: Nov. 27, 2025

(54) THERMOOPTICAL SYSTEM FOR RAPID THERMOCYCLING OF DIGITAL PCR CHIP AND HIGH TEMPERATURE UNIFORMITY FOR DIGINAL MELT ANALYSIS

(71) Applicants: GE Precision Healthcare LLC, Waukesha, WI (US); THE JOHNS HOPKINS UNIVERSITY, Baltimore, MD (US)

(72) Inventors: Christopher Michael Puleo, Niskayuna, NY (US); Ralf Lenigk, Niskayuna, NY (US); Tejas Suresh Khire, San Mateo, CA (US); Eric Uriah Schneider, Catonsville, MD (US); Kayleigh Elizabeth Boyle, Baltimore, MD (US); Anton Podkovirin, Cockeysville, MD (US); Edward Robert Prescott, Baltimore, MD (US); Michael Scott Damiani, Baltimore, MD (US); Rachael Catherine Scott, Baltimore, MD (US); Tza-Huei Jeff Wang, Timonium, MD (US); Christine Mangione O'Hersey, White Marsh, MD (US); Pei-Wee Lee, Baltimore, MD (US); Dong Jin Park, Middle River, MD (US)

(21) Appl. No.: 18/673,770

(22) Filed: May 24, 2024

(51) Int. Cl. B01L 7/00

(52) U.S. Cl. CPC B01L 7/52; B01L 2200/02; B01L 2300/0654; B01L 2300/1805; B01L 2300/1894; B01L 2400/0487

(57) ABSTRACT

A system includes a thermocycling assembly configured to perform thermocycling for a digital polymerase chain reaction (PCR). The thermocycling assembly includes a flat thermal plate having a first side configured to contact and to thermally interface with a flat digital PCR cartridge including thousands of chambers for samples. The thermocycling assembly also includes a heat sink disposed beneath the flat thermal plate including an internal liquid conduit. The thermocycling assembly further includes thermal electric cooling elements disposed between the flat thermal plate and the heat sink, wherein the thermal electric cooling elements are configured to regulate a temperature of the flat thermal plate during the thermocycling. The thermocycling assembly even further includes a liquid cooling system coupled to the heat sink and configured to flow a liquid through the internal liquid conduit to facilitate rapid cooling of the flat thermal plate during thermocycling.

### STATEMENT REGARDING FEDERALLY SPONSORED RESEARCH & DEVELOPMENT

This invention was made with US Government support under contract number DTRA 2018-342-1 awarded by Defense Threat Reduction Agency. The Government has certain rights in the invention.

### BACKGROUND

The subject matter disclosed herein relates to a thermooptical system for rapid thermocycling of a digital polymerase chain reaction chip (digital PCR chip) and high temperature uniformity for digital melt analysis.

The current workflow for analyzing infections (e.g., bacterial infections) from biological patients of patients in order to determine the appropriate treatment (e.g., antibiotic) takes multiple days. Yet the patient's infection needs to be treated as soon as possible. However, giving drugs to a patient before knowing the drug resistance status of the particular bacterial strains responsible for the infections may result in generating resistant bacterial strains, increasing hospital stays, increasing cost, and increasing risk of death. Thus, there is a need to generate a quicker system for performing antimicrobial susceptibility tests.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a system is provided. The system includes a thermocycling assembly configured to perform thermocycling for a digital polymerase chain reaction (PCR). The thermocycling assembly includes a flat thermal plate having a first side configured to contact and to thermally interface with a flat digital PCR cartridge including thousands of chambers for samples. The thermocycling assembly also includes a heat sink disposed beneath the flat thermal plate including an internal liquid conduit. The thermocycling assembly further includes thermal electric cooling elements disposed between the flat thermal plate and the heat sink, wherein the thermal electric cooling elements are configured to regulate a temperature of the flat thermal plate during the thermocycling. The thermocycling assembly even further includes a liquid cooling system coupled to the heat sink and configured to flow a liquid through the internal liquid conduit to facilitate rapid cooling of the flat thermal plate during thermocycling.

In another embodiment, a thermooptical system is provided. The thermooptical system includes a thermocycling assembly configured to perform thermocycling for a digital polymerase chain reaction (PCR). The thermocycling assembly includes a flat thermal plate having a first side configured to contact and to thermally interface with a flat digital PCR cartridge including thousands of chambers for samples. The thermocycling assembly is configured to enable a ramp rate during the thermocycling of 8 degrees Celsius or greater per second. The thermocycling assembly is configured to regulate the temperature of the flat thermal plate to provide a uniform temperature across a thermal interface between the flat thermal plate and the flat digital PCR cartridge at a high enough temperature to enable digital high resolution melt analysis across an entirety of the chambers of the flat digital PCR cartridge. The thermooptical system also includes an optical imaging system to acquire imaging data for the digital high resolution melt analysis via wide field imaging. The optical imaging system and the thermocycling assembly are disposed together in a single housing

In a further embodiment, a method is provided. The method includes performing thermocycling, via a thermocycling assembly, during a digital polymerase chain reaction (PCR). The thermocycling assembly includes a flat thermal plate having a first side configured to contact and to thermally interface with a flat digital PCR cartridge including thousands of chambers for samples. The thermocycling assembly is configured to enable a ramp rate during the thermocycling of 8 degrees Celsius or greater per second. The method also includes regulating, via the thermocycling assembly, a temperature of the flat thermal plate to provide a uniform temperature across a thermal interface between the flat thermal plate and the flat digital PCR cartridge across an entirety of the chambers of the flat digital PCR cartridge during a digital high resolution melt analysis.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 is a schematic diagram of a system for rapid thermocycling of a digital polymerase chain reaction chip and high temperature uniformity for digital melt analysis, in accordance with aspects of the present disclosure;

FIG. 2 is a perspective view of the system in FIG. 1, in accordance with aspects of the present disclosure;

FIG. 3 is a perspective view of the system in FIG. 1 (e.g., with portions of the housing removed), in accordance with aspects of the present disclosure;

FIG. 4 is a perspective view of a rear portion of the system in FIG. 1, in accordance with aspects of the present disclosure;

FIG. 5 is a front view of a front portion of the system in FIG. 1 with a door open, in accordance with aspects of the present disclosure;

FIG. 6 is a perspective view of the system in FIG. 1 with a portion of a housing removed, in accordance with aspects of the present disclosure;

FIG. 7 is an exploded view of a portion of a thermocycling assembly, in accordance with aspects of the present disclosure;

FIG. 8 is perspective view of a bottom of a heat sink of a thermocycling assembly, in accordance with aspects of the present disclosure;

FIG. 9 is a top view of the heat sink in FIG. 8, in accordance with aspects of the present disclosure;

FIG. 10 is a view of a bottom of a thermal plate of a thermocycling assembly, in accordance with aspects of the present disclosure;

FIG. 11 is a perspective view of a portion of a thermocycling assembly, in accordance with aspects of the present disclosure;

FIG. 12 is a schematic diagram illustrating a thermistor mapping of a thermocycling assembly, in accordance with aspects of the present disclosure;

FIG. 13 depicts a graph and a table illustrating a ramping of temperature on a top side of thermal electric cooling elements, in accordance with aspects of the present disclosure;

FIG. 14 depicts a table illustrating a ramping of temperature on a glass chip via a thermocycling assembly, in accordance with aspects of the present disclosure;

FIG. 15 depicts a table illustrating a temperature uniformity during thermal melt on a top side of thermal electric cooling elements, in accordance with aspects of the present disclosure;

FIG. 16 depicts a table illustrating a temperature uniformity during thermal melt on a glass chip via a thermocycling assembly, in accordance with aspects of the present disclosure;

FIG. 17 depicts a table illustrating a temperature uniformity on a top side of thermal electric cooling elements during a polymerase chain reaction cycle, in accordance with aspects of the present disclosure; and

FIG. 18 depicts a thermal profile across a glass chip device during a particular melting temperature, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

Some generalized information is provided to provide both general context for aspects of the present disclosure and to facilitate understanding and explanation of certain of the technical concepts described herein.

The term processor, processing system, or processing unit, as used herein, refers to any type of processing unit that can carry out the required calculations needed for the various embodiments, such as single or multi-core: CPU, Accelerated Processing Unit (APU), Graphics Board, DSP, FPGA, ASIC or a combination thereof.

As used herein, the terms “automatic” and “automatically” refer to actions that are performed by a computing device or computing system (e.g., of one or more computing devices) without human intervention. For example, automatically performed functions may be performed by computing devices or systems based solely on data stored on and/or received by the computing devices or systems despite the fact that no human users have prompted the computing devices or systems to perform such functions. As but one non-limiting example, the computing devices or systems may make decisions and/or initiate other functions based solely on the decisions made by the computing devices or systems, regardless of any other inputs relating to the decisions.

The present disclosure provides for a system (e.g., thermooptical system) for rapid thermocycling of a digital polymerase chain reaction chip and high temperature uniformity for digital melt analysis. In particular, the system provides a single integrated system that includes all the optical and thermocycling components (including an interface for a digital PCR cartridge having a low thermal profile) needed for performing both rapid amplification (e.g., via digital PCR) on samples (e.g., 10 to 60 minute PCR processing) and high resolution digital high resolution digital melt analysis. For example, the system enables the rapid amplification of long recombinant deoxyribonucleic acid (rDNA) or recombinant ribonucleic acid (rRNA) amplicons (e.g., 100s of base pairs) from biological samples. In addition, the system enables a similar heating uniformity across an entire array (e.g., entire digital PCR cartridge) to enable accurate detection across the whole array. The system enables the identification of pathogen biomarkers (e.g., of a polymicrobial infection) without culture and simultaneous phenomolecular antimicrobial susceptibility testing.

The embodiments include a system that includes a thermocycling assembly configured to perform thermocycling for a digital polymerase chain reaction (PCR). The thermocycling assembly includes a flat thermal plate having a first side configured to contact and to thermally interface with a flat digital PCR cartridge including thousands (e.g., 10,000s) of chambers (e.g., wells) for samples. The thermocycling assembly also includes a heat sink disposed beneath the flat thermal plate including an internal liquid conduit. The thermocycling assembly further includes thermal electric cooling elements disposed between the flat thermal plate and the heat sink, wherein the thermal electric cooling elements are configured to regulate a temperature of the flat thermal plate during the thermocycling. The thermocycling assembly even further includes a liquid cooling system coupled to the heat sink and configured to flow a liquid through the internal liquid conduit to facilitate rapid cooling of the flat thermal plate during thermocycling. The thermocycling assembly can be utilized for both the digital polymerase chain reaction and digital high resolution melt analysis (via regulation of the temperature of the interface (i.e., flat thermal plate) with the flat digital PCR cartridge.

In certain embodiments, the thermocycling assembly is configured to enable a ramp rate during the thermocycling of 8 degrees Celsius or greater per second. In certain embodiments, the thermocycling assembly includes a plurality of thermistors disposed between the heat sink and the flat thermal plate to monitor a temperature on both sides of the thermal electric cooling elements. In certain embodiments, the plurality of thermistors includes a first set of thermistors disposed on a second side of the flat thermal plate opposite the first side. In certain embodiments, the plurality of thermistors includes a second set of thermistors disposed on a side of the heat sink that faces the thermal electric cooling elements. In certain embodiments, the liquid cooling system includes a pump assembly coupled to tubing coupled to the heat sink, wherein the pump assembly is disposed within the housing and is configured to regulate flow of liquid into and out of the heat sink via the tubing.

In certain embodiments, the thermal electric cooling elements are configured to regulate the temperature of the flat thermal plate to provide a uniform temperature across a thermal interface between the flat thermal plate and the flat digital PCR cartridge at a high enough temperature to enable digital high resolution melt analysis across an entirety of the chambers of the flat digital PCR cartridge. In certain embodiments, the system includes an optical imaging system configured to acquire imaging data for the digital high resolution melt analysis via wide field imaging. In certain embodiments, the optical imaging system and the thermocycling assembly are disposed together in a single housing. In certain embodiments, the optical imaging system includes a camera and a pair of light emitting diode arrays. In certain embodiments, the system includes a vibration isolation platform, wherein the vibration isolation platform is configured to support portions of the thermocycling assembly and to dampen vibrations to enable the optical imaging system to acquire the imaging data during operation of the thermocycling assembly.

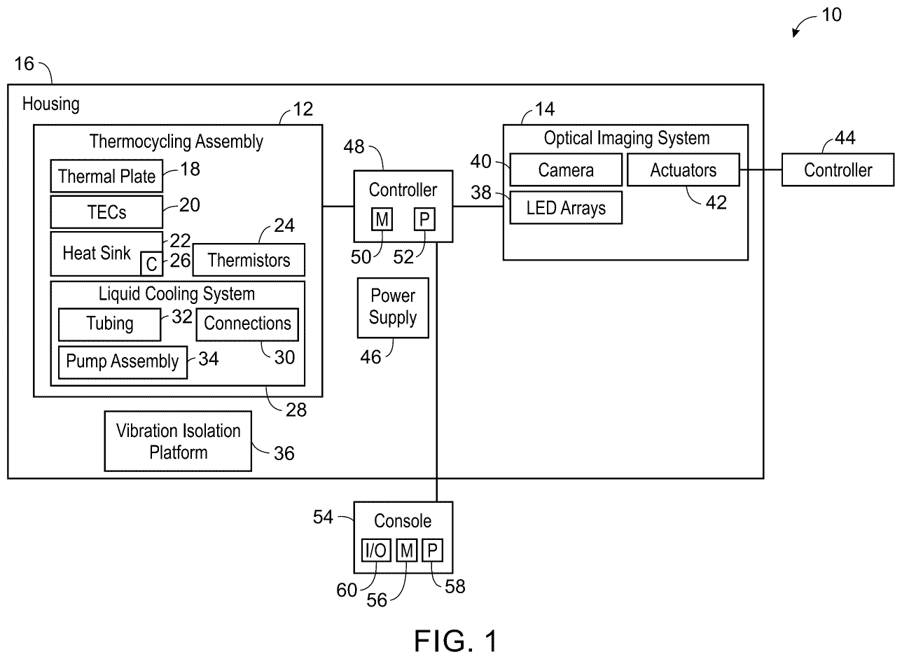

FIG. 1 is a schematic diagram of a system 10 (e.g., thermooptical system) for rapid thermocycling of a digital polymerase chain reaction chip (e.g., cartridge) and high temperature uniformity for digital melt analysis. The system 10 includes a thermocycling assembly 12 and an optical imaging system 14. The thermocycling assembly 12 is configured to perform rapid thermocycling (e.g., with a ramp rate of 8 degrees Celsius or greater per second) for digital polymerase chain reaction. The optical imaging system 14 is configured to acquire imaging data for digital high resolution melt analysis via wide field imaging. The thermocycling assembly 12 is also configured for used during digital high resolution melt analysis. The thermocycling assembly 12 and the optical imaging system 14 form a single integrated system that are disposed together with a single housing 16. The housing 16 may be formed by multiple components (e.g., service cover, back panel of power supply, etc.).

The thermocycling assembly 12 includes a thermal plate 18 (e.g., heating/cooling plate). In certain embodiments, the thermal plate 18 is flat. In certain embodiments, the thermal plate 18 is made of metal. A first side (e.g., top side) of the thermal plate 18 is configured to contact and to thermally interface with a bottom of a flat digital PCR cartridge or device when the digital PCR cartridge is placed in a receptacle. The flat digital PCR cartridge has thousands (10,000s) of chambers or wells for samples. The flat digital PCR cartridge may range between 2 to 10 centimeters in length. The thermal plate 18 provides a heating/cooling area large enough to interface with an entirety of the array (i.e., entire bottom of flat digital PCR cartridge).

The thermocycling assembly 12 also includes a plurality of thermal electric cooling elements (TECs) 20 (which are coupled to TEC controllers). The thermal electric cooling elements 20 (and, thus, thermocycling assembly 12) is configured to regulate a temperature of the thermal plate 18 during thermocycling (e.g. during digital PCR and digital high resolution melt analysis). In certain embodiments, the thermal electric cooling elements 20 are configured to regulate the temperature of thermal plate 18 to provide a uniform temperature across a thermal interface (despite a low thermal profile of the interface) between the thermal plate 18 and the digital PCR cartridge at a high enough temperature to enable digital high resolution melt analysis across an entirety of the array (i.e., chambers) of the digital PCR cartridge. The thermocycling assembly 12 further includes a heat sink 22 disposed beneath the thermal plate 18. The thermal electric cooling elements 20 are disposed between the thermal plate 18 and the heat sink 22. The thermal electric cooling elements 20 are configured to transfer heat between the thermal plate 18 and the heat sink 22.

The thermocycling assembly 12 further includes a plurality of thermistors 24. Thermistors are disposed between the heat sink 22 and the thermal plate 18 to monitor a respective temperature on both sides of the thermal electric cooling elements 20. In certain embodiments, a first set of thermistors 24 are disposed on a second side of the thermal plate 18 opposite the first side that interfaces with the digital PCR cartridge. In certain embodiments, a second set of thermistors 24 are disposed on a side of the heat sink 22 that faces the thermal electric cooling elements 20. Thermistors 24 may also be associated with other components of the thermocycling assembly 12.

The heat sink 22 includes an internal liquid conduit 26 for fluid to act as a heat exchanger. The thermocycling assembly 12 includes a liquid cooling system 28 coupled to the heat sink 22 and configured to flow a liquid through the internal liquid conduit 26 to facilitate rapid cooling of the thermal plate 18 during thermocycling. The thermal transfer properties between the thermal plate 18 and the digital PCR cartridge enable a ramp rate of 8 degrees Celsius or greater per second during thermocycling. This enables rapid PCR processing (e.g., 10 to 60 minute PCR processing).

The liquid cooling system 28 includes connections 30 (e.g., located on the heat sink 22) for coupling to tubing 32. The liquid cooling system 28 includes a pump assembly 34 coupled to the tubing 32 coupled to the heat sink 22. The pump assembly 34 is configured to regulate flow of liquid into and out of the heat sink 22 (i.e., the internal liquid conduit 26 of the heat sink 22). The thermocycling assembly 12 may include other components not shown in FIG. 1.

The system 10 includes a vibration isolation platform 36 disposed within the housing 16. The vibration isolation platform 36 is configured to support portions of the thermocycling assembly 12. The vibration isolation platform 36 is also configured to dampen vibrations to enable the optical imaging system 14 to acquire the imaging data during operation of the thermocycling assembly 12.

The optical imaging system 14 includes light emitting diode (LED) arrays 38 (e.g., a pair of LED arrays 38) and associated components (e.g., cooling fans, heat sinks, filters, etc.) to emit light at different wavelengths (e.g., between 470 and 490 nanometers) for digital high resolution melt analysis. The optical imaging system 14 also includes a camera 40 to acquire the imaging data for the digital high resolution melting analysis via wide field imaging. The optical imaging system 14 also includes actuators 42. For example, an actuator 42 (e.g., adjustment rail and associated bearing) may be utilized to alter a position of the camera 40 (e.g., up and down). In certain embodiments, another actuator 42 (e.g., motorized gear) may be utilized to alter the focus of the camera 40. In certain embodiments, the system 10 may include a controller 44 (e.g., remote controller) located outside the housing 16 that a user may utilize to alter the focus of the camera 40 via one of the actuators 42.

The system 10 also includes a power supply 46 that when coupled to an electrical outlet provides power to the system 10. The system 10 further includes a controller 48 disposed within the housing 16. The controller 48 is communicatively coupled to both the thermocycling assembly 12 and the optical imaging system 14. The controller 48 is configure to provide control signals to control (e.g., automatically control) the thermocycling assembly 12 and the optical imaging system 14 and their respective components. The controller 48 includes a memory 50 storing instructions and a processing system 52 to execute the instructions on the memory 50. The controller 48 is also communicatively coupled to a console 54 (or computing device) located outside the housing 16. The console 54 includes a memory 56 storing instructions and a processing system 58 to execute instruction on the memory 56. The console 54 also includes input/output devices 60. The input devices may include a keyboard, touchscreen, microphone, mouse, and/or other input devices. The output device may include a speaker, a display, and/or other output devices. In certain embodiments, instructions may be provided from the console 54 to the controller 48. In certain embodiments, acquired data may be provided to console 54 for analysis and/or visualization. As an example, the memories 50, 56 may store processor-executable software code or instructions (e.g., firmware or software), which are tangibly stored on a non-transitory computer readable medium. Additionally or alternatively, the memories 50, 56 may store data. As an example, the memories 50, 56 may include a volatile memory, such as random access memory (RAM), and/or a nonvolatile memory, such as read-only memory (ROM), flash memory, a hard drive, or any other suitable optical, magnetic, or solid-state storage medium, or a combination thereof. Furthermore, the processing systems 52, 58 may include multiple microprocessors, one or more “general-purpose” microprocessors, one or more special-purpose microprocessors, and/or one or more application specific integrated circuits (ASICS), or some combination thereof. For example, the processing systems 52, 58 may include one or more reduced instruction set (RISC) or complex instruction set (CISC) processors. The processing systems 52, 58 may include multiple processors, and/or the memories 50, 56 may include multiple memory devices. The system 10 may include other components not shown in FIG. 1.

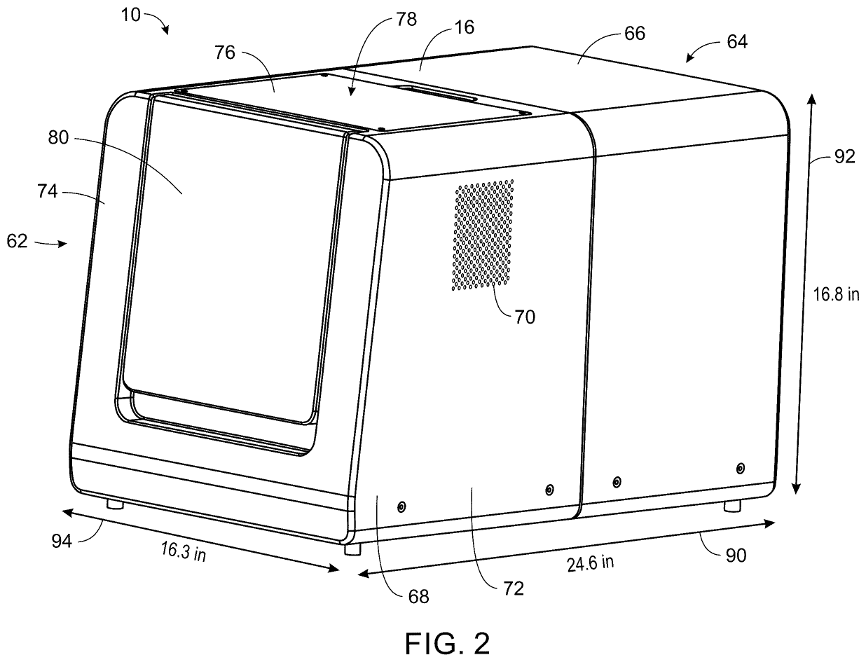

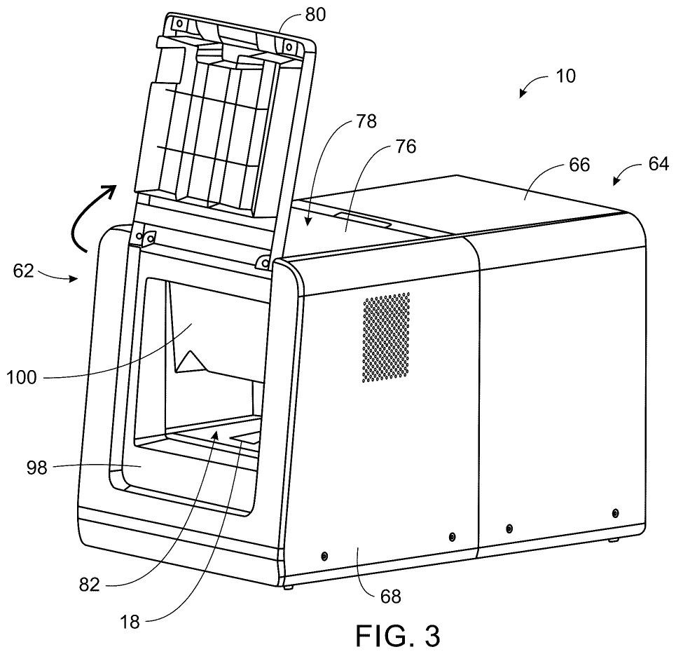

FIG. 2 is a perspective view of the system 10 (e.g., thermooptical system) in FIG. 1. As depicted, the system 10 is enclosed within the housing 16. The system 10 has a front portion 62 and a rear portion 64. The housing 16 is defined by multiple components. For example, the housing 16 includes a rear enclosure 66 covering internal components of the system 10 in the rear portion 64. The housing 16 also includes a front enclosure 68 covering internal components of the system 10 in the front portion 62. The front enclosure 68 includes holes 70 on sides 72, 74 corresponding to the location of the LED arrays for the removal of heat from inside the housing 16. The front enclosure 68 also includes an access panel 76 located on a top portion 78 of the front enclosure 68. The access panel 76 may removed to access the components of the optical imaging system from the top. The front enclosure 68 further includes a door 80 on a front of the front enclosure 68. In certain embodiments, an inner surface of the door 80 may include an optical interlock switch to keep the door 80 closed during operation of the system 10 (e.g., during digital PCR and during digital high resolution melt analysis). The door 80 is configured to be opened in a circumferential direction toward the top portion 78 of the front enclosure 68. FIG. 3 depicts the system 10 with the door 80 opened. With the door 80 opened, the digital PCR cartridge may be inserted into and/or removed from a receptacle 82 within the housing 16. When the digital PCR cartridge is disposed within the receptacle 82, the bottom surface of digital PCR cartridge directly contacts the thermal plate 18 of the thermocycling assembly 12 within the housing 16.

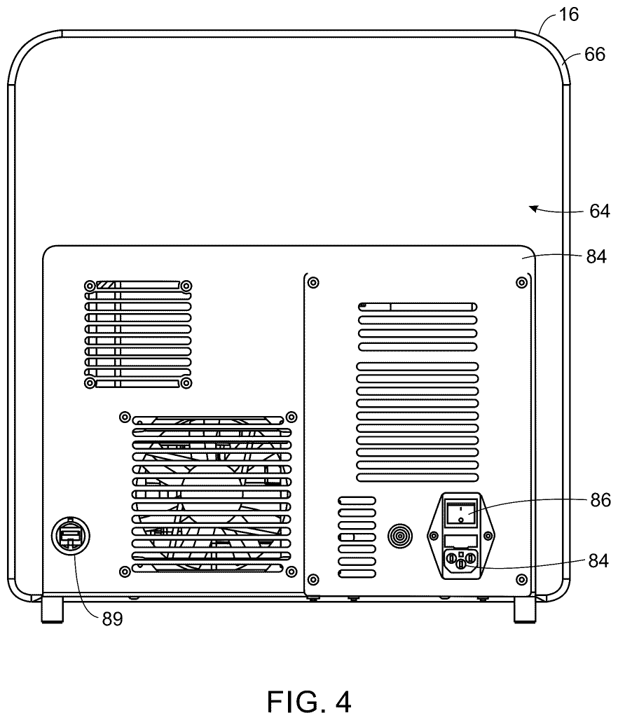

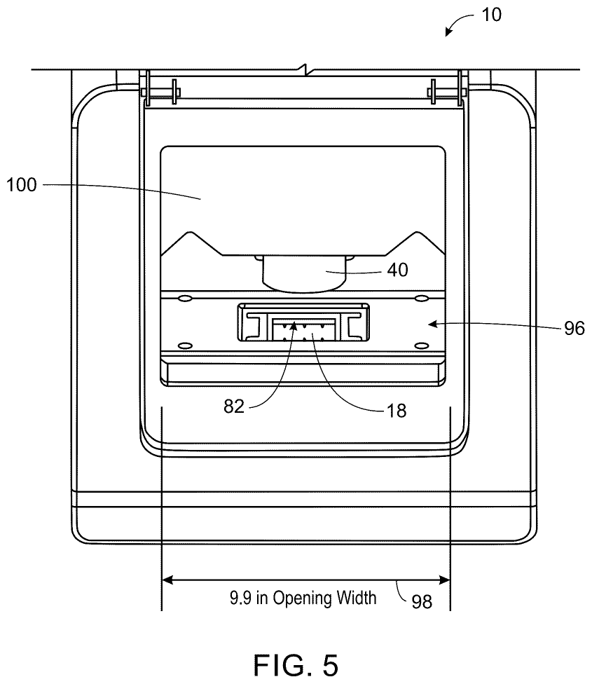

The housing 16 also includes a back panel 84 located on the rear portion 64 of the system 10 as depicted in FIG. 4. The back panel 84 includes an on/off switch 86 and power ports 88. The back panel 84 may also include a standard universal serial bus port 89. The different portions of the housing 16 serve as modular service panels that can be removed to access components of the system 10.

As depicted, the system 10 has a compact design. The system 10 includes a length 90, a height 92, and a width 94. The length 90, the height 92, and the width 94 may vary. As depicted, the length 90 is 24.6 inches (62.48 centimeters (cm)), the height 92 is 16.8 inches (42.67 cm), and the width 94 is 16.3 inches (41.4 cm). As depicted in FIGS. 3 and. 5, when the door 80 is open, an opening 96 into the housing 16 has a width 98 that provides a large enough clearance for inserting/removing the digital PCR cartridge. As depicted, the width is 9.9 inches (25.15 cm). The system 10 also includes a light shield 100 (e.g., having a tortuous path) disposed within the housing 16 as part of the optical imaging system that extends across a portion of the opening 96. The camera 40 is disposed directly over the area where the digital PCR cartridge is inserted.

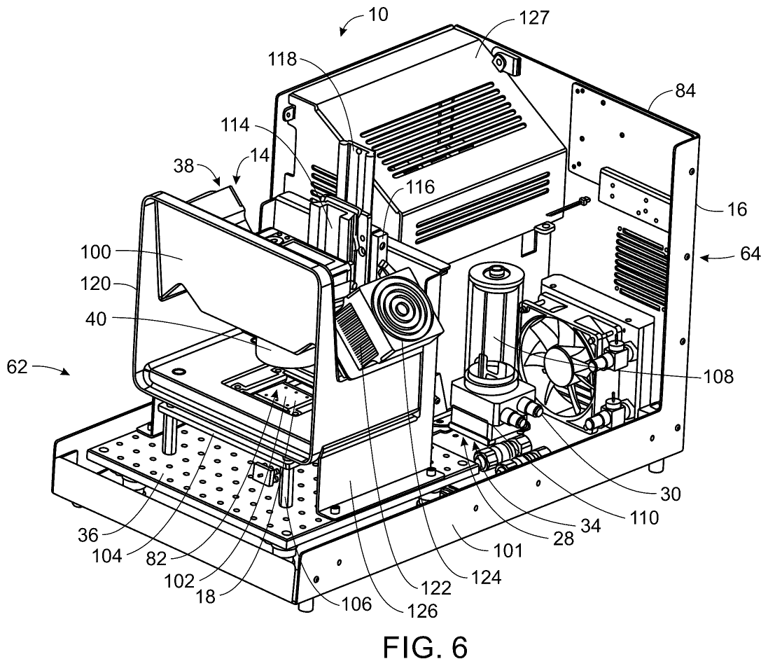

FIG. 6 is a perspective view of the system 10 in FIG. 1 with a portion of the housing 16 removed (e.g., rear enclosure 66 and front enclosure 68 removed). As depicted, the system 10 includes the thermocycling assembly 12 disposed adjacent the front portion 62 and the optical imaging system 14 located above the thermocycling assembly 12. The components of the system are located on a frame 101. The thermocycling assembly 12 includes the thermal plate 18 (e.g., heating/cooling plate) located within the receptacle 82. In certain embodiments, the thermal plate 18 is flat. In certain embodiments, the thermal plate 18 is made of metal. A first side (e.g., top side) 102 of the thermal plate 18 is configured to contact and to thermally interface with a bottom of a flat digital PCR cartridge or device when the digital PCR cartridge is placed in a receptacle 82.

Portions of the thermocycling assembly 12 (e.g., the thermal plate 18, thermal electric cooling elements, heat sink, etc.) are disposed on a top surface of a base plate 104. The base plate 104 is coupled to legs 106. The legs 106 raise the thermocycling assembly 12 above the vibration isolation platform 36 that the thermocycling assembly 12 is disposed on, thus, providing space for tubing (not shown) to couple to a bottom of the heat sink. The vibration isolation platform 36 is configured to support portions of the thermocycling assembly 12. The vibration isolation platform 36 is also configured to dampen vibrations to enable the optical imaging system 14 to acquire the imaging data during operation of the thermocycling assembly 12.

Portions of the liquid cooling system 28 of thermocycling assembly 12 are depicted in FIG. 6. The liquid cooling system 28 includes connections 30 for coupling to tubing. The liquid cooling system 28 includes the pump assembly 34 that is configured to couple to the tubing coupled to the heat sink. The pump assembly 34 is configured to regulate flow of liquid into and out of the heat sink (i.e., the internal liquid conduit of the heat sink). The pump assembly 34 includes a reservoir body 108 (e.g., for holding the liquid that acts as a heat exchanger) coupled to a pump 110. The pump 110 has the connections 30 for coupling to the tubing. The system 10 also includes a cooling fan 112 located adjacent the pump assembly 34 near the rear portion 64 (in particular, the back panel 84).

The optical imaging system 14 includes the LED arrays 38 (e.g., a pair of LED arrays 38) and associated components (e.g., cooling fans, heat sinks, filters, etc.) to emit light at different wavelengths (e.g., between 470 and 490 nanometers) for digital high resolution melt analysis. The optical imaging system 14 also includes the camera 40 to acquire the imaging data for the digital high resolution melting analysis via wide field imaging. As depicted, the camera 40 is orientated at the location where the digital PCR cartridge is inserted. As depicted, the LED arrays 38 flank the camera 40 and are oriented to direct the emitted light at the location where the digital PCR cartridge is inserted. The camera 40 is coupled to a focusing rack 114. The focusing rack 114 is coupled to a wide sleeve bearing carriage 116 that move the camera 40 (e.g., up and down) along an adjustment rail 118.

The optical imaging system 14 includes an enclosure 120 that the camera 40 and the light emitting portions of the LED arrays 38 are disposed within. The LED arrays 38 are coupled to the enclosure 120. The enclosure 120 includes the light shield 100. Each LED array 38 includes a heat sink 122 and a cooling fan 124 disposed outside the enclosure 120.

Portions of the optical imaging system 14 (e.g., the camera 40 via the carriage 116 and the adjustment rail 118) are coupled to a frame 126. The frame 126 supports the camera 40. The frame 126 is coupled to the vibration isolation platform 36. Also, as depicted in FIG. 6, the system 10 encloses electronics (e.g., controller, power supply, etc.) within a power enclosure 127 (e.g., sheet metal power enclosure).

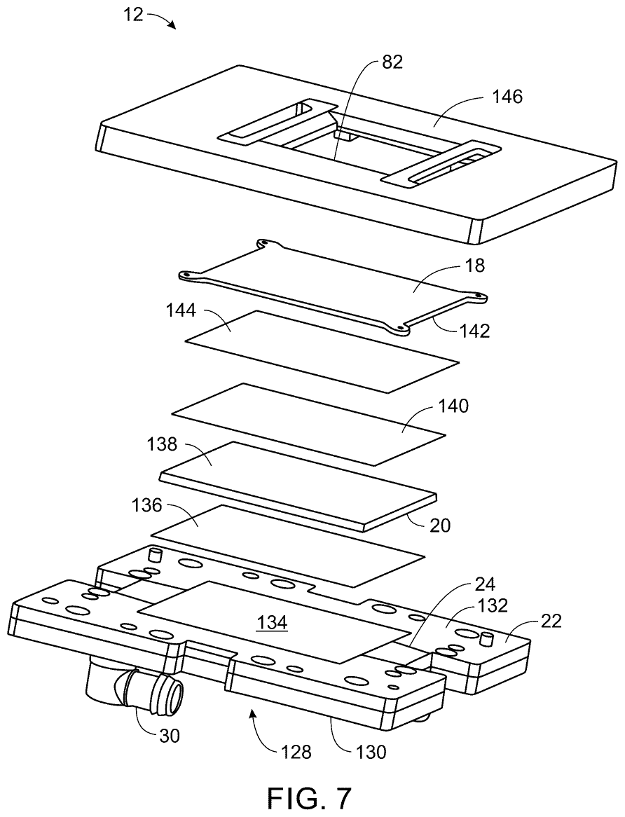

FIG. 7 is an exploded view of a portion of the thermocycling assembly 12. On a bottom portion 128 is located the heat sink 22. A bottom side or surface 130 of the heat sink 22 includes a pair of connections 30 configured to couple the tubing of the liquid cooling system to both ends of an internal liquid conduit disposed within the heat sink 22. The heat sink 22 may be formed as a single part or multiple parts. As depicted, the heat sink 22 is formed by multiple parts. A set of thermistors 24 are disposed on a top side or surface 132 of the heat sink 22. An adhesive pad 134 is centrally disposed on (and contacts) the top side 132 of heat sink over a portion of each of thermistors 24. A compressible graphite pad 136 is disposed over (and contacts) the adhesive pad 134. The thermal electric cooling elements 20 are disposed over (and contact) the compressible graphite pad 136. As depicted, there are four thermal electric cooling elements 20. The number of thermal electric cooling elements 20 may vary. An adhesive pad 138 is disposed on (and contacts) the TECs 20. The adhesive pad 138 holds the thermal electric cooling elements together. A compressible graphite pad 140 is disposed over (and contacts) the adhesive pad 138. The thermal plate 18 is disposed over the compressible graphite pad 140. A set of thermistors (not shown) are located on a bottom side or surface 142 of the thermal plate 18. An adhesive pad 144 is disposed on (and contacts) the bottom side 142 of the thermal plate 18 covering the thermistors. The top side 102 of the thermal plate 18 is configured to form the thermal interface with a flat bottom surface of the digital PCR cartridge. A clamping plate 146 is disposed over the thermal plate 18 and the components below the thermal plate 18. The clamping plate 146 in conjunction with the thermal plate 18 forms the receptacle 82.

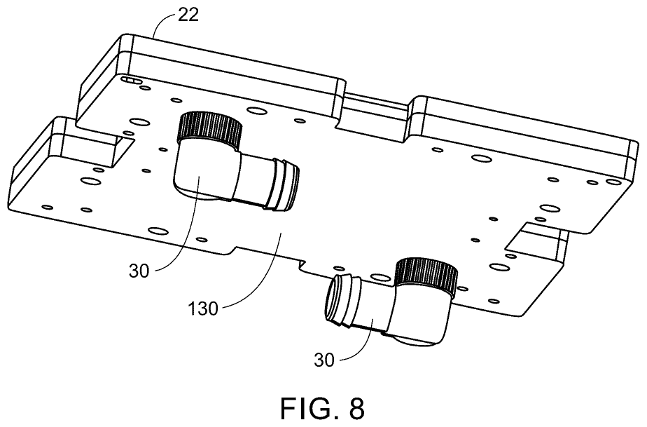

FIG. 8 is perspective view of a bottom of the heat sink 22 (e.g., heat sink assembly) of the thermocycling assembly. As depicted, a pair of connections 30 (e.g., barbed elbow fittings) are coupled to the bottom side 130 of the heat sink 22. The connections 30 are configured to couple to tubing of the liquid cooling system that is coupled to the pump assembly 34. The pump assembly regulates flow of liquid into and out of the heat sink 22 (i.e., the internal liquid conduit of the heat sink 22), where the liquid acts as heat exchanger to enable rapid cooling during thermocycling by the thermocycling assembly.

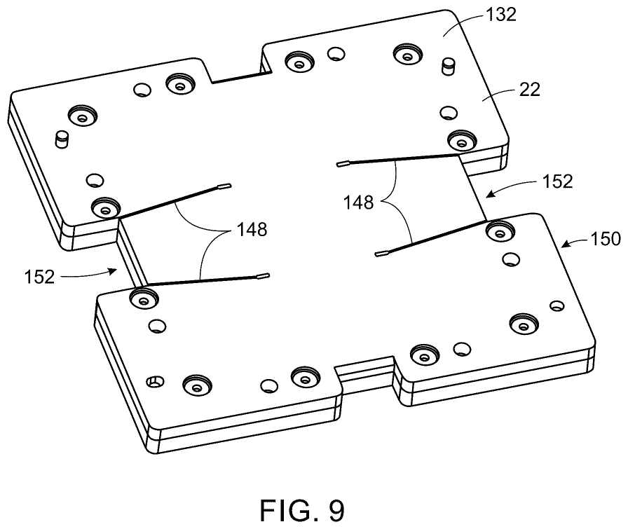

FIG. 9 is a top view of the heat sink 22 in FIG. 8. As depicted, the top side 132 of the heat sink 22 includes receptacles 148 for receiving a set of thermistors. As depicted, the heat sink 22 includes four receptacles 148 for receiving a respective thermistor. The number of receptacles 148 may vary. Adjacent the receptacles 148, an outer perimeter 150 of the heat sink 22 forms a pair of recesses 152 for printed circuit boards for the thermistors of the thermocycling assembly to be disposed within.

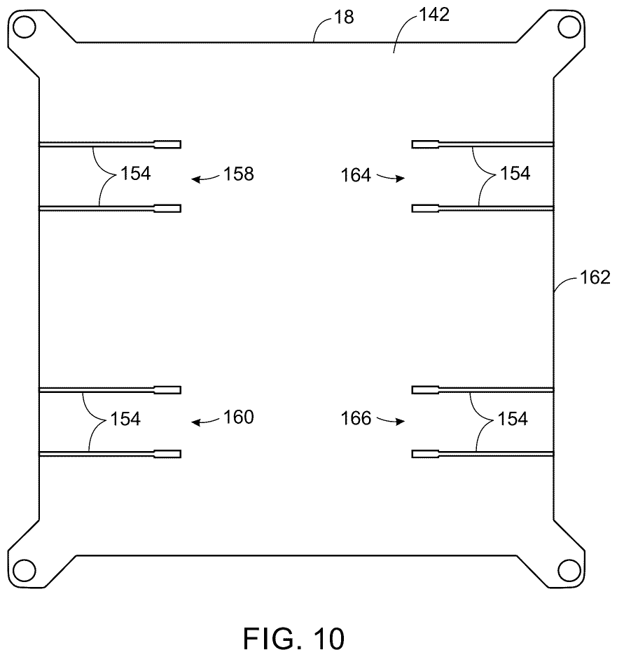

FIG. 10 is a view of a bottom of the thermal plate 18 of a thermocycling assembly. As depicted, the bottom side 142 of the includes a plurality of receptacles 154 for receiving for thermistors. A first side 156 of the thermal plate 18 includes a first pair 158 of receptacles 154. The first side 156 of the thermal plate 18 also includes a second a pair 160 of receptacles disposed adjacent to the first pair 158 of receptacles 154. A second side 162 (opposite the first side 156) of the thermal plate 18 includes a third pair 164 of receptacles 154. The second side 162 of the thermal plate 18 also includes a fourth pair 166 of receptacles 154 disposed adjacent the first pair of receptacles 154.

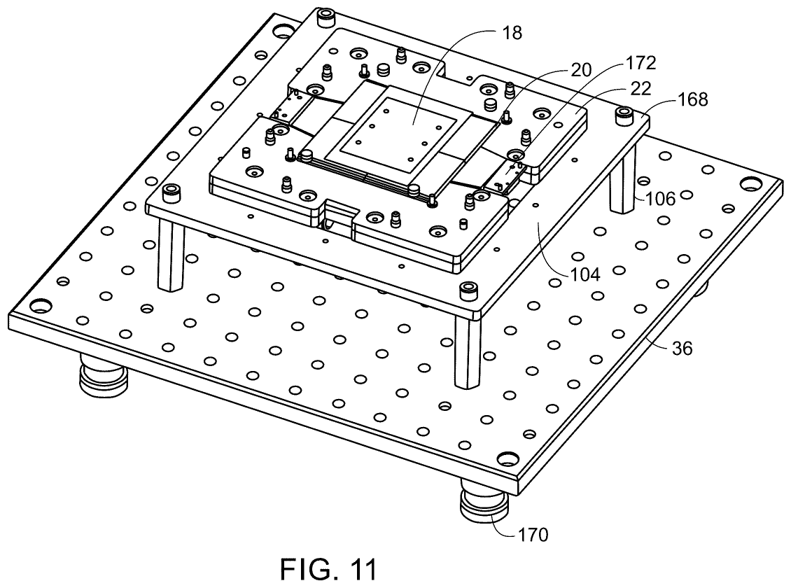

FIG. 11 is a perspective view of a portion of the thermocycling assembly 12 (without the clamping plate). In FIG. 11, components of the thermocycling assembly 12 shown in FIG. 7 assembled together and disposed on a top surface 168 of a base plate 104. The base plate 104 is coupled to legs 106. The legs 106 raise the thermocycling assembly 12 above the vibration isolation platform 36 that the thermocycling assembly 12 is disposed on, thus, providing space for tubing (not shown) to couple to a bottom of the heat sink. The vibration isolation platform 36 (and associated vibration feet 170 coupled to the platform 36) is configured to support portions of the thermocycling assembly 12. The vibration isolation platform 36 is also configured to dampen vibrations to enable the optical imaging system 14 to acquire the imaging data during operation of the thermocycling assembly 12. Also, as depicted in FIG. 11, printed circuit boards 172 for the thermistors are disposed with the pair of recesses 152 in the heat sink 22.

FIG. 12 is a schematic diagram illustrating a thermistor mapping of the thermocycling assembly 12. The upper right portion of FIG. 12 includes a schematic diagram of the thermocycling assembly 12 associated with a glass chip 174 (e.g., flat digital PCR cartridge or device). The thermocycling assembly 12 includes the heat sink 22. A plurality of thermal electric cooling elements 20 are disposed on the heat sink 22. The thermocycling assembly 12 also includes the thermal plate 18 (e.g., flat thermal plate) disposed on the plurality of thermal electric cooling elements 20. The thermal plate 18 may be made of metal. The digital PCR cartridge 174 is disposed on the top side 102 of the thermal plate 18. The top side 102 of the thermal plate 18 is configured to contact and to thermally interface with a bottom side 176 of the flat digital PCR cartridge or device 174 when the digital PCR cartridge is placed in a receptacle. The flat digital PCR cartridge 174 has thousands (10,000s) of chambers or wells for samples. The flat digital PCR cartridge 174 may range between 2 to 10 centimeters in length. The thermal plate 18 provides a heating/cooling area large enough to interface with an entirety of the array (i.e., entire bottom 176 of flat digital PCR cartridge 174).

As depicted, the thermal plate 18 includes a first set 178 of thermistors 24. The upper right portion of FIG. 12 is a top view of the thermocycling assembly 12 with the clamping plate 146 disposed over the thermal plate 18. The first set 178 of thermistors 24 are disposed on the bottom side 142 of the thermal plate 18. In particular, the first set 178 of thermistors 24 includes a first pair 180 of thermistors 24 (T7 and T8) disposed on the bottom side 142 on the first side 156 of the thermal plate 18. The first set 178 of thermistors 24 also includes a second pair 182 of thermistors 24 (T5 and T6) disposed on the bottom side 142 on the first side 156 of the thermal plate 18 adjacent to the first pair 180 of thermistors 24. The first set 178 of thermistors 24 further includes a third pair 184 of thermistors 24 (T1 and T2) disposed on the bottom side 142 on the second side 162 (opposite the first side 156) of the thermal plate 18. The first set 178 of thermistors 24 further includes a fourth pair 186 of thermistors 24 (T3 and T4) disposed on the bottom side 142 on the second side 162 of the thermal plate 18 adjacent to the third pair 184 of thermistors 24. The first pair 180 of thermistors 24 are disposed across from the third pair 184 of thermistors 24. The second pair 182 of thermistors 24 are disposed across from the fourth pair 186 of thermistors 24. The first set 178 of thermistors 24 is configured to monitor a temperature on a top side 188 of the thermal electric cooling elements 20. As mentioned above, the thermocycling assembly 12 may include four thermal electric cooling elements 20 (designated Heater 1, Heater 2, Heater 3, and Heater 4) in the upper right side of FIG. 12. The first pair 180 of thermistors 24 are configured to monitor a temperature of the top side 188 of the Heater 4 TEC. The second pair 182 of thermistors 24 are configured to monitor a temperature of the top side 188 of the Heater 3 TEC. The third pair 184 of thermistors 24 are configured to monitor a temperature of the top side 188 of the Heater 1 TEC. The fourth pair 186 of thermistors 24 are configured to monitor a temperature of the top side 188 of the Heater 2 TEC.

As depicted, the heat sink 22 includes a second set 190 of thermistors 24. The lower left portion of FIG. 12 is a top view of the heat sink 22. The second set 190 of thermistors 24 includes a first pair 192 of thermistors 24 (T15 and T16) disposed adjacent the recess 152 on a first side 194 of the heat sink 22. The second set 190 of thermistors 24 includes a second pair 196 of thermistors 24 (T12 and T13) disposed adjacent the recess 152 on a second side 198 (opposite the first side 194) of the heat sink 22. The first pair 192 of thermistors 24 is disposed across from the second pair 196 of thermistors 24. The second set 190 of thermistors 24 is configured to monitor a temperature on a bottom side 200 of the thermal electric cooling elements 20.

As depicted, the thermocycling assembly 12 includes an additional thermistor 24 (T9) associated with an upstream portion 202 of the liquid cooling system. The additional thermistor 24 (T9) may monitor the temperature of the liquid flowing into the heat sink 22. The thermocycling assembly 12 also includes an additional thermistor 24 (T10) associated with a downstream portion 204 of the liquid cooling system. The additional thermistor 24 (T10) may monitor the temperature of the liquid flowing from the heat sink 22. The thermocycling assembly 12 further includes an additional thermistor 24 (T11) configured to monitor an ambient temperature within the enclosure of the thermooptical system (as indicated by reference numeral 206). The thermocycling assembly 12 even further an additional thermistor 24 (T14) that is not used (as indicated by reference numeral 208).

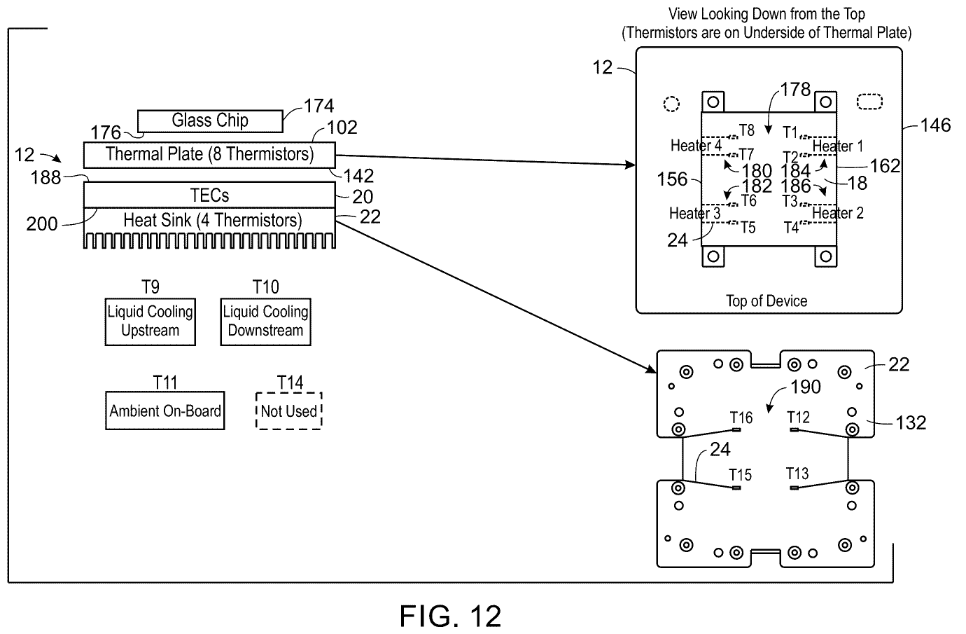

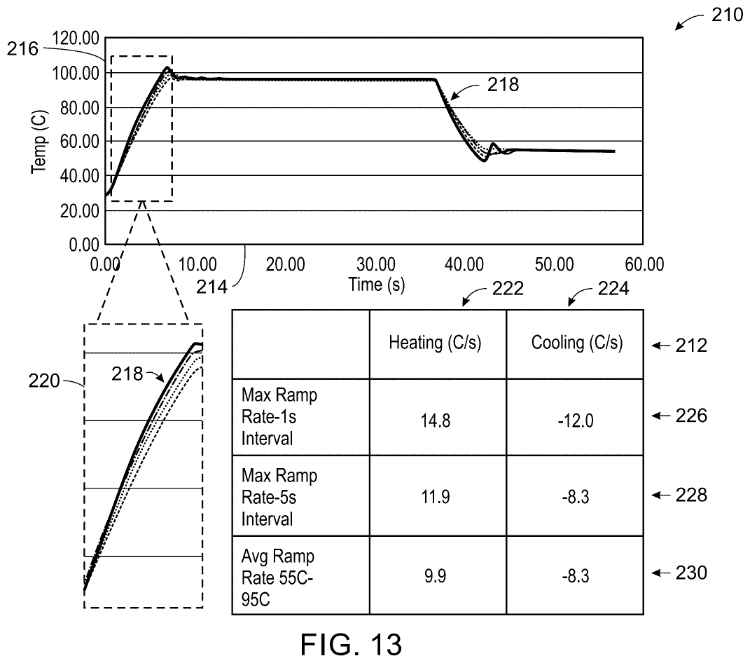

FIG. 13 depicts a graph 210 and a table 212 illustrating a ramping of temperature (e.g., for heating and cooling) on the top side of thermal electric cooling elements of the thermocycling assembly. In particular, temperature measurements were gathered from each thermistor 24 of the first set 178 of thermistors 24 (T1-T8) located on the bottom side 142 of the thermal plate 18 depicted in FIG. 12.

The graph 210 represents the average temperature measurements from the first set 178 of thermistors 24 over three runs. The graph 210 includes an x-axis 214 representing time (in seconds(s)). The graph 210 also include a y-axis 216 representing temperature (in degrees Celsius (C)). The graph 210 includes plots 218 representing the respective temperature measurements from the respective thermistors 24 of the first set 178 of thermistors 24. Zoomed portion 220 represents the portion of the graph 210 during ramping between 55 degrees Celsius and 95 degrees Celsius.

The table 212 summarizes the data within the zoomed portion 220 of the graph 210. The table 212 includes a first column 222 representing heating in degrees Celsius per second. The table 212 also includes a second column 224 representing cooling in degrees Celsius per second. The table 212 further includes a first row 226 representing a maximum ramp rate over a one second interval. The table 212 even further includes a second row 228 representing a maximum ramp rate over a five second interval. The table 212 yet further includes a third row 230 representing an average ramp rate between 55 degrees Celsius and 95 degrees Celsius. As shown by the results in the table 212, the thermocycling assembly is configured to enable a ramp rate during the thermocycling of 8 degrees Celsius or greater per second.

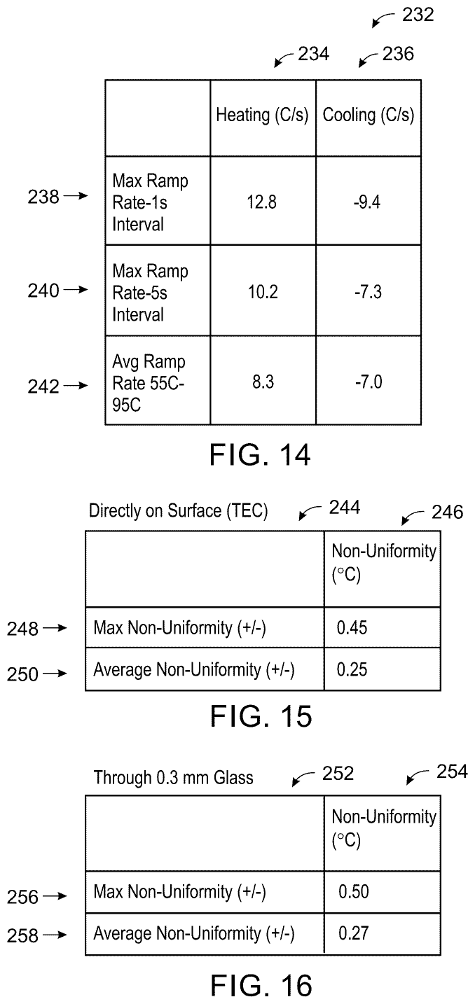

FIG. 14 depicts a table 232 illustrating a ramping of temperature on a glass chip (e.g., digital PCR cartridge) via a thermocycling assembly (e.g., the thermocycling assembly 12 described in FIG. 1). Temperature measurements were gathered from five external thermistors disposed on the glass chip. The glass chip has a thickness of 3 millimeters. The table 232 represents the average temperature measurements gathered from the five external thermistors over three runs.

The table 232 includes a first column 234 representing heating in degrees Celsius per second. The table 232 also includes a second column 236 representing cooling in degrees Celsius per second. The table 232 further includes a first row 238 representing a maximum ramp rate over a one second interval. The table 232 even further includes a second row 240 representing a maximum ramp rate over a five second interval. The table 232 yet further includes a third row 242 representing an average ramp rate between 55 degrees Celsius and 95 degrees Celsius. As shown by the results in the table 232, the thermocycling assembly is configured to enable a ramp rate during the thermocycling of 8 degrees Celsius or greater per second (and a corresponding change in temperature on the glass chip due to the thermal interface with the thermal plate of the thermocycling assembly).

FIG. 15 depicts a table 244 illustrating a temperature uniformity during thermal melt on the top side of thermal electric cooling elements of the thermocycling assembly. In particular, temperature measurements were gathered from each thermistor 24 of the first set 178 of thermistors 24 (T1-T8) located on the bottom side 142 of the thermal plate 18 depicted in FIG. 12. The temperature measurements were gathered from the thermistors 24 during the ramping of the melt analysis (e.g., digital high resolution high melt analysis).

The table 244 includes a column 246 representing non-uniformity (in degrees Celsius) across the top side of the thermal electric cooling elements. The table 244 also includes a first row 248 representing the maximum non-uniformity (±) across the top side of the thermal electric cooling elements. The table 244 further includes a second row 250 representing average non-uniformity (±) across the top side of the thermal electric cooling elements. As depicted in table 244, the temperature across the top side of thermal electric cooling elements is substantially uniform (with an average non-uniformity of ±0.25 degrees Celsius and a maximum non-uniformity of ±0.45 degrees Celsius).

FIG. 16 depicts a table 252 illustrating a temperature uniformity during thermal melt on a glass chip (e.g., digital PCR cartridge) via a thermocycling assembly (e.g., the thermocycling assembly 12 described in FIG. 1). Temperature measurements were gathered from five external thermistors disposed on the glass chip. The glass chip has a thickness of 3 millimeters. The temperature measurements were gathered from the thermistors during the ramping of the melt analysis (e.g., digital high resolution high melt analysis).

The table 252 includes a column 254 representing non-uniformity (in degrees Celsius) across the glass chip. The table 252 also includes a first row 256 representing the maximum non-uniformity (±) across the glass chip. The table 252 further includes a second row 258 representing average non-uniformity (±) across the glass chip. As depicted in table 252, the temperature across the glass chip is substantially uniform (with an average non-uniformity of ±0.27 degrees Celsius and a maximum non-uniformity of ±0.50 degrees Celsius).

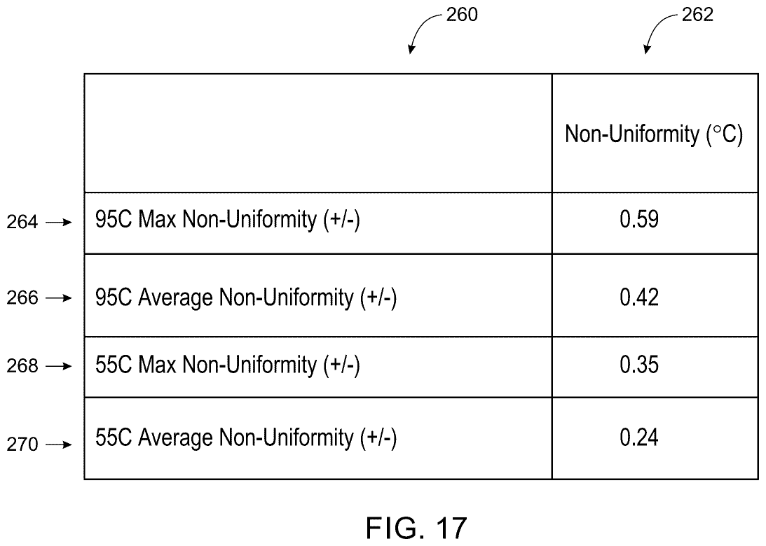

FIG. 17 depicts a table 260 illustrating a temperature uniformity on the top side of thermal electric cooling elements of the thermocycling assembly during a polymerase chain reaction (PCR) cycle. In particular, temperature measurements were gathered from each thermistor 24 of the first set 178 of thermistors 24 (T1-T8) located on the bottom side 142 of the thermal plate 18 depicted in FIG. 12. The temperature measurements were gathered from the thermistors 24 during both a 95 degrees Celsius time window and a 55 degrees Celsius time window during the PCR cycle (e.g., digital PCR cycle).

The table 260 includes a column 262 representing non-uniformity (in degrees Celsius) across the top side of the thermal electric cooling elements. The table 260 also includes a first row 264 representing the maximum non-uniformity (±) across the top side of the thermal electric cooling elements during the 95 degrees Celsius time window of the PCR cycle. The table 260 further includes a second row 266 representing average non-uniformity (±) across the top side of the thermal electric cooling elements during the 95 degrees Celsius time window of the PCR cycle. The table 260 also includes a third row 268 representing the maximum non-uniformity (±) across the top side of the thermal electric cooling elements during the 55 degrees Celsius time window of the PCR cycle. The table 260 further includes a fourth row 270 representing average non-uniformity (±) across the top side of the thermal electric cooling elements during the 55 degrees Celsius time window of the PCR cycle. As depicted in table 260, the temperature across the top side of thermal electric cooling elements is substantially uniform during the 95 degrees Celsius time window of the PCR cycle (with an average non-uniformity of ±0.42 degrees Celsius and a maximum non-uniformity of ±0.59 degrees Celsius). Also, as depicted in table 260, the temperature across the top side of thermal electric cooling elements is substantially uniform during the 55 degrees Celsius time window of the PCR cycle (with an average non-uniformity of ±0.35 degrees Celsius and a maximum non-uniformity of +0.24 degrees Celsius).

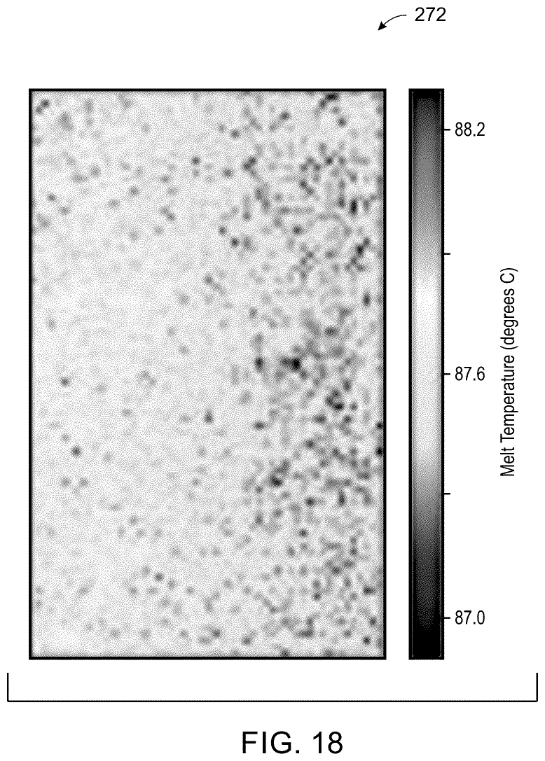

FIG. 18 depicts an example of a thermal profile 272 across a glass chip device (e.g., digital PCR cartridge) during a melting of DNA (e.g., E. coli DNA) acquired with the thermooptical system described herein. The glass chip device included 5017 wells. The mean melt temperature across the glass chip device was 87.6 degrees Celsius. The 3 sigma was 0.4. The variation in the melting temperature across the glass chip was less than 0.5 degrees Celsius.

Technical effects of the disclosed embodiments include providing a system (e.g., thermooptical system) for rapid thermocycling of a digital polymerase chain reaction chip and high temperature uniformity for digital melt analysis. In particular, the system provides a single integrated system that includes all the optical and thermocycling components (including an interface for a digital PCR cartridge having a low thermal profile) needed for performing both rapid amplification (e.g., via digital PCR) on samples (e.g., 10 to 60 minute PCR processing) and high resolution digital high resolution digital melt analysis. For example, the system enables the rapid amplification of long recombinant deoxyribonucleic acid (rDNA) or recombinant ribonucleic acid (rRNA) amplicons (e.g., 100s of base pairs) from biological samples. Technical effects of the disclosed embodiments include providing a system that enables a similar heating uniformity across an entire array (e.g., entire digital PCR cartridge) to enable accurate detection across the whole array. Technical effects of the disclosed embodiments further include providing a system that enables the identification of pathogen biomarkers (e.g., of a polymicrobial infection) without culture and simultaneous phenomolecular antimicrobial susceptibility testing.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a thermocycling assembly configured to perform thermocycling for a digital polymerase chain reaction (PCR), comprising:
a flat thermal plate having a first side configured to contact and to thermally interface with a flat digital PCR cartridge including thousands of chambers for samples;
a heat sink disposed beneath the flat thermal plate comprising an internal liquid conduit;
thermal electric cooling elements disposed between the flat thermal plate and the heat sink, wherein the thermal electric cooling elements are configured to regulate a temperature of the flat thermal plate during the thermocycling; and
a liquid cooling system coupled to the heat sink and configured to flow a liquid through the internal liquid conduit to facilitate rapid cooling of the flat thermal plate during thermocycling.

2. The system of claim 1, wherein thermocycling assembly is configured to enable a ramp rate during the thermocycling of 8 degrees Celsius or greater per second.

3. The system of claim 1, wherein the thermocycling assembly comprises a plurality of thermistors disposed between the heat sink and the flat thermal plate to monitor a temperature on both sides of the thermal electric cooling elements.

4. The system of claim 3, wherein the plurality of thermistors comprises a first set of thermistors disposed on a second side of the flat thermal plate opposite the first side.

5. The system of claim 4, wherein the plurality of thermistors comprises a second set of thermistors disposed on a side of the heat sink that faces the thermal electric cooling elements.

6. The system of claim 1, wherein the thermal electric cooling elements are configured to regulate the temperature of the flat thermal plate to provide a uniform temperature across a thermal interface between the flat thermal plate and the flat digital PCR cartridge at a high enough temperature to enable digital high resolution melt analysis across an entirety of the chambers of the flat digital PCR cartridge.

7. The system of claim 6, further comprising an optical imaging system configured to acquire imaging data for the digital high resolution melt analysis via wide field imaging.

8. The system of claim 7, wherein the optical imaging system and the thermocycling assembly are disposed together in a single housing.

9. The system of claim 7, wherein the optical imaging system comprises a camera and a pair of light emitting diode arrays.

10. The system of claim 7, further comprising a vibration isolation platform, wherein the vibration isolation platform is configured to support portions of the thermocycling assembly and to dampen vibrations to enable the optical imaging system to acquire the imaging data during operation of the thermocycling assembly.

11. A thermooptical system, comprising:
a thermocycling assembly configured to perform thermocycling for a digital polymerase chain reaction (PCR), wherein the thermocycling assembly comprises a flat thermal plate having a first side configured to contact and to thermally interface with a flat digital PCR cartridge including thousands of chambers for samples, the thermocycling assembly is configured to enable a ramp rate during the thermocycling of 8 degrees Celsius or greater per second, and the thermocycling assembly is configured to regulate a temperature of the flat thermal plate to provide a uniform temperature across a thermal interface between the flat thermal plate and the flat digital PCR cartridge at a high enough temperature to enable digital high resolution melt analysis across an entirety of the chambers of the flat digital PCR cartridge; and
an optical imaging system to acquire imaging data for the digital high resolution melt analysis via wide field imaging, wherein the optical imaging system and the thermocycling assembly are disposed together in a single housing.

12. The thermooptical system of claim 11, wherein thermocycling assembly further comprises:
a heat sink disposed beneath the flat thermal plate comprising an internal liquid conduit; and
thermal electric cooling elements disposed between the flat thermal plate and the heat sink, wherein the thermal electric cooling elements are configured to regulate a temperature of the flat thermal plate during the thermocycling.

13. The thermooptical system of claim 12, wherein thermocycling assembly further comprises a liquid cooling system coupled to the heat sink and configured to flow a liquid through the internal liquid conduit to facilitate rapid cooling of the flat thermal plate during thermocycling.

14. The thermooptical system of claim 13, wherein the liquid cooling system comprises a pump assembly coupled to tubing coupled to the heat sink, wherein the pump assembly is disposed within the single housing and is configured to regulate flow of liquid into and out of the heat sink via the tubing.

15. The thermooptical system of claim 12, wherein the thermocycling assembly comprises a plurality of thermistors disposed between the heat sink and the flat thermal plate to monitor a temperature on both sides of the thermal electric cooling elements.

16. The thermooptical system of claim 15, wherein the plurality of thermistors comprises a first set of thermistors disposed on a second side of the flat thermal plate opposite the first side.

17. The thermooptical system of claim 16, wherein the plurality of thermistors comprises a second set of thermistors disposed on a side of the heat sink that faces the thermal electric cooling elements.

18. The thermooptical system of claim 11, further comprising a vibration isolation platform, wherein the vibration isolation platform is configured to support portions of the thermocycling assembly and to dampen vibrations to enable the optical imaging system to acquire the imaging data during operation of the thermocycling assembly.

19. A method, comprising:
performing thermocycling, via a thermocycling assembly, during a digital polymerase chain reaction (PCR), wherein the thermocycling assembly comprises a flat thermal plate having a first side configured to contact and to thermally interface with a flat digital PCR cartridge including thousands of chambers for samples, wherein the thermocycling assembly is configured to enable a ramp rate during the thermocycling of 8 degrees Celsius or greater per second; and
regulating, via the thermocycling assembly, a temperature of the flat thermal plate to provide a uniform temperature across a thermal interface between the flat thermal plate and the flat digital PCR cartridge across an entirety of the chambers of the flat digital PCR cartridge during a digital high resolution melt analysis.

20. The method of claim 19, acquiring, via an optical imaging system, imaging data for the digital high resolution melt analysis via wide field imaging, wherein the optical imaging system and the thermocycling assembly are disposed together in a single housing.
